(19) United States
(12) Patent Application Publication
(10) Pub. No.: US 2018/0127258 A1
(43) Pub. Date: May 10, 2018

(54) DRINK PRODUCING APPARATUS WITH DISTANCE SETTING DEVICE, HOUSEHOLD REFRIGERATION APPARATUS AS WELL AS METHOD FOR PRODUCING AND DISPENSING A DRINK

(71) Applicant: BSH HAUSGERAETE GMBH, MUENCHEN (DE)

(72) Inventors: KUDRET BAYSAL, GIENGEN BRENZ (DE); DELIA HAHN, HEIDENHEIM AN DER BRENZ (DE); CARSTEN WEISS, GIENGEN (DE)

(21) Appl. No.: 15/346,760

(22) Filed: Nov. 9, 2016

(51) Int. Cl. B67D 1/08; B67D 1/00; F25D 23/12

(52) U.S. Cl. CPC B67D 1/0882; B67D 1/0016; B67D 1/0861; F25D 23/12; B67D 1/0021; B67D 1/0078; B67D 1/0894

(57) ABSTRACT

A drink producing apparatus includes:
a dispensing unit for dispensing carbonized liquid from the drink producing apparatus,
a dispensing container, which is formed for receiving a carbonized liquid addable to a drink by the drink producing apparatus, wherein
the dispensing container is connected to the dispensing unit of the drink producing apparatus for leading the carbonized liquid from the dispensing container to the dispensing unit,
the dispensing unit comprises a dispensing opening, from which the carbonized liquid can be dispensed,
a receiving device for receiving a vessel, wherein the carbonized liquid to be dispensed from the dispensing opening can be filled into the vessel,
a position variation device, by which a position between the dispensing opening and the receiving device is variable, and
a distance setting device, by which a vertical distance between the dispensing opening and a local reference location at or in the vessel is kept constant during the dispensing process of the carbonized liquid.

The invention also relates to a household refrigeration apparatus and to a method for producing and dispensing a mixed drink.

### TECHNICAL FIELD

The invention relates to a drink producing apparatus with a dispensing container, which is formed for receiving a liquid addable to a drink by the drink producing apparatus. The drink producing apparatus moreover includes a dispensing unit, to which the dispensing container is connected for supplying the liquid from the dispensing container to the dispensing unit. Furthermore, the invention also relates to a household refrigeration apparatus with such a drink producing apparatus as well as to a method for producing and dispensing a drink.

### PRIOR ART

From DE 196 15 106 A1, a method and a device for continuously producing soda water or soda-like water are known. A device is disclosed there, in which different liquids like lemonade, beer, wine can be present in different separate containers. Each container is connected to an own tap and is thus separated from the other container. Producing and dispensing a mixed drink of different liquids in the containers is not possible there in the interior of the system itself. Furthermore, the taps are far apart such that introducing liquids from different taps into a drinking vessel at the same time is not possible.

From WO 2007/141321 A2, a household refrigeration apparatus is known, which has a drink apparatus, which is formed for dispensing a drink at this household refrigeration apparatus itself.

Moreover, cold drink machines are also known, in which alcohol containing mixed drinks, for example cocktails, can be dispensed

In known drink producing apparatuses for dispensing cooled drinks, mixing of the liquid jet with other additions upon dispensing is restricted.

Especially carbonized and thus liquids mixed with carbonic acid lose carbonic acid in filling into the vessel, whereby the quality of the drink is decreased.

### PRESENTATION OF THE INVENTION

It is the object of the present invention to provide a drink producing apparatus as well as a household refrigeration apparatus as well as a method for producing a drink, by which or in which the preparation of carbonized drinks is improved and loss of carbonic acid in filling into a vessel is reduced.

This object is solved by a drink producing apparatus, a household refrigeration apparatus and a method according to the independent claims.

A first independent aspect of the invention relates to a drink producing apparatus. The drink producing apparatus has a dispensing unit, which is formed for dispensing carbonized liquid from the drink producing apparatus. The drink producing apparatus has a dispensing container, which is formed for receiving a carbonized liquid addable to the drink by the drink producing apparatus. The dispensing container is connected to the dispensing unit of the drink producing apparatus for leading the carbonized liquid from the dispensing container to the dispensing unit. The dispensing unit has a dispensing opening, from which the carbonized liquid can be dispensed. The drink producing apparatus has a receiving device for receiving a vessel, wherein the carbonized liquid to be dispensed from the dispensing opening can be introduced into the vessel. Moreover, the drink producing apparatus includes a position variation device, by which a position between the dispensing opening and the receiving device is variable. The drink producing apparatus also has a distance setting device, by which a vertical distance between the dispensing opening and a surface of the carbonized liquid filled into the vessel is kept constant during the dispensing process of the carbonized liquid. Thereby, it is achieved that the height of fall of the dispensed liquid is minimized and thus the impact is reduced upon impingement of the liquid on the vessel bottom or the surface of the liquid then already introduced into the vessel and thus the exit of carbonic acid from the liquid is reduced since the splash of the impinging jet of the liquid after impingement is also reduced. By such a configuration of a drink producing apparatus, the dispensing of carbonized liquid is improved and undesired severe exit of carbonic acid from this liquid in the dispensing process is avoided.

By this keeping this vertical distance constant in filling the vessel with the liquid, a dynamic procedure is performed to the effect that the distance between the vessel and thus also the receiving device and the dispensing opening is varied and in particular increased in this context. Namely, when the liquid is filled into the vessel, thus, the amount of liquid in the vessel increases with proceeding dispensing process, such that the filling level rises there. In order to also avoid undesired immersion of the dispensing opening into the liquid already filled into the vessel in this context, on the other hand not to cause an undesired large distance between the surface of the liquid and the dispensing opening, this keeping constant is essential. Upon impingement of the liquid in the vessel, for example at the start of the dispensing process on an inner side of the vessel and in the proceeding dispensing process on the surface of the already filled liquid, therefore, too high height of fall of this liquid is not effected. By this preferred, relatively small vertical distance, which is also preferably less than 10 cm, in particular less than 8 cm, in particular less than 6 cm, an undesired high height of fall of the liquid dispensed from the dispensing opening is avoided during the entire dispensing process and thereby undesired severe impact and severe splash of the liquid in the vessel is avoided. Namely, this severe impact and splash cause undesired severe exit of the carbonic acid from the liquid.

In particular, it is provided that the distance setting device has at least one detector unit, via which the surface of the liquid in the vessel is detectable in non-contacting manner with the liquid. The detector unit can be an optical detector unit and for example represent an infrared detector unit. Thereby, the non-contact capture can be very securely and robustly effected and also be allowed through walls of the vessel. Moreover, the infrared signal and thus the corresponding beam are not visible to the human eye by this infrared detector unit and capture in obscurity is here virtually performed, which is not immediately recognizable by the user.

It can also be provided that the detector unit is an ultrasonic sensor. In particular in such a configuration, an ultrasonic signal is then emitted to the surface of the liquid via the filling opening of the vessel and the corresponding desired constant distance can here then also be effected depending thereon in dynamic filling the liquid in the dispensing process.

In particular in such a configuration, the vertical distance between this specific detector unit and the dispensing opening is then kept constant during the dispensing process. It can be provided that the position variation device is formed for height adjustment and/or for tilting the receiving device and/or for height adjustment and/or for tilting the dispensing opening. Thereby, individual movement scenarios of the dispensing opening and the receiving device to each other can be effected and thus individual position variations can be set. This entails advantages with respect to differently sized and differently shaped vessels, which can be placed on the receiving device. For very different vessels, therefore, adequate movement scenarios can be effected to keep the vertical distance constant, as was explained above.

In a preferred implementation, the drink producing apparatus has a capturing device, which is formed for capturing at least one geometric quantity of a vessel, into which the liquid to be dispensed is to be filled when the vessel is disposed on the receiving device. The geometric quantity can be a height of the vessel.

The distance setting device can be formed for communication with the position variation device, and an orientation of the vessel in space and/or a height position of the vessel and/or a speed of a position variation of the vessel can be variable depending on the captured surface of the liquid in the vessel in a dispensing process of the liquid. Thereby, the vertical distance between the dispensing opening and the surface of the liquid in the vessel is then kept constant. The same can then also be effected in addition or instead with the dispensing opening, whereby the vertical distance between the dispensing opening and the surface of the liquid in the vessel is then also kept constant at this place.

Preferably, it is provided that the drink producing apparatus has a capsule with an addition medium separate from the dispensing container, which can then be added to the jet of the liquid in producing the mixed drink. Such an addition medium can be liquid, gelatinous or powdery. In this context, addition media individual both in taste and in color can then be present, which impart corresponding specifications to the mixed drink.

In particular, it is provided that the drink producing apparatus has at least one second dispensing container, which is formed for receiving a second liquid addable to the in particular cooled mixed drink by the drink producing apparatus, wherein this second dispensing container is connected to the dispensing unit of the drink producing apparatus for leading the second liquid from the second dispensing container to the dispensing unit, wherein the first liquid and the second liquid are mixed to the jet dispensed from the dispensing opening. In this configuration, thus, a mixed drink of two different liquids is already present at the dispensing opening, which can then in particular be mixed with the jet of the addition medium from the capsule.

It can be provided that a liquid, in particular the first liquid, is water or contains water and the second liquid is alcohol or contains alcohol.

In particular, the two liquids also have different freezing points.

In particular, the first dispensing container is cooled by a cooling device of the drink producing apparatus. The cooling device is in particular a refrigeration circuit. The refrigeration circuit in particular includes an evaporator thermally coupled to the dispensing container such that the dispensing container can be cooled by the cold energy of the evaporator and thus the first liquid in particular present in the dispensing container is then also cooled thereby.

In particular, the preferably present second dispensing container can also be cooled by the cooling device. Here too, the thermal coupling to a refrigeration circuit is in particular provided, which is preferably the refrigeration circuit, by which the first dispensing container is also cooled. Here too, it is preferably provided that the second dispensing container is thermally coupled to an own, separate evaporator and is cooled via the cold energy thereof. Especially if the two liquids have different freezing points, the cooling with separate cooling units, in particular separate evaporators, is advantageous to be able to individually adjust adequate temperatures without one of the two liquids freezing.

In addition, it can also be provided that the drink producing apparatus is formed for receiving a capsule, in which additives, which can be added to the mixed drink, are contained. Additives can be powdery or gelatinous or also liquid. In this context, the capsule can then be introduced into a dispensing area of the drink producing apparatus and this ingredient of the capsule can then also be automatically dispensed or admixed or already be admixed upon dispensing the mixed drink.

A further aspect of the invention relates to a household refrigeration apparatus, which is formed for storing and preserving food. The household refrigeration apparatus has a housing, in which a receiving space for food is formed. Moreover, the household refrigeration apparatus includes a drink producing apparatus. The drink producing apparatus has a dispensing unit for dispensing carbonized liquid from the drink producing apparatus. Moreover, it has a dispensing container, which is formed for receiving a carbonized liquid addable to a drink by the drink producing apparatus. The dispensing container is connected to the dispensing unit of the drink producing apparatus for leading the carbonized liquid from the dispensing container to the dispensing unit. The dispensing unit has a dispensing opening, from which the carbonized liquid can be dispensed. Moreover, a receiving device for receiving a vessel is present. The carbonized liquid to be dispensed from the dispensing opening can be filled into the vessel when the vessel is disposed in the receiving device. Moreover, a position variation device is provided, by which a position between the dispensing opening and the receiving device is variable. A distance setting device is also provided, by which a vertical distance between the dispensing opening and a surface of the carbonized liquid filled into the vessel is kept constant during the dispensing process of the carbonized liquid.

The household refrigeration apparatus can be a refrigerator or a freezer or a combined refrigerator-freezer.

Furthermore, the invention also relates to a method for producing and dispensing a drink by a drink producing apparatus. In the method, a dispensing container is provided, which is formed for receiving a carbonized liquid addable to a drink by the drink producing apparatus. A dispensing unit of the drink producing apparatus is provided and the dispensing unit is connected to the dispensing container for leading the carbonized liquid from the dispensing container to the dispensing unit. A vessel is placed on a receiving device of the drink producing apparatus. A jet of the at least one carbonized liquid is dispensed from the dispensing opening of the dispensing unit into the vessel. A surface of the liquid in the vessel is captured during the dispensing process. A position between the dispensing opening and the receiving device is varied during the dispensing process of the carbonized liquid, wherein this variation is effected such that a vertical distance between the dispensing opening and the surface is kept constant during the dispensing process of the carbonized liquid.

According to an advantageous implementation, before dispensing the carbonized liquid from the dispensing opening, a basic position between the dispensing opening and the vessel is set and the vessel and the dispensing opening are moved away from each other in their position to each other during the dispensing process such that the vertical distance between the dispensing opening and the surface of the liquid already dispensed into the vessel is kept constant. The basic position is set such that the desired vertical reference distance is already reached before the dispensing process such that this reference distance is then also maintained as a corresponding vertical distance during the dispensing process. For reaching the basic position, after placing the vessel on the receiving position, the vessel is moved into this basic position, wherein thereto it is moved closer towards the dispensing opening starting from this placing position reached in placement or the dispensing opening is moved closer towards the vessel. A distance between the vessel and the dispensing opening in the mentioned placing position is therefore larger than the basic position then to be set. In particular, it is provided that the vertical distance between the dispensing opening and the surface of the liquid in the vessel is kept constant during the dispensing process of the carbonized liquid from the dispensing opening depending on the type of the liquid, which is dispensed into the vessel.

In an advantageous implementation, it is provided that the drink producing apparatus is disposed in a receiving area of the household refrigeration apparatus in particular separate from the receiving space for food. This receiving area can be formed in an interior container bounding the receiving space with its walls. However, it can also be provided that the receiving area is formed in an interior container separate from this interior container bounding the receiving space with its walls. These interior containers or this interior container are or is disposed in the housing.

The receiving space, in particular only the receiving space, is closable on the front side by a door pivotably supported at the housing. In this context, it can be provided that the household refrigeration apparatus is formed such that only one receiving space is present, which is for example a refrigerating compartment or a freezing compartment, which is closable by an own door. However, it can also be provided that such a single receiving space is closable by two doors, which are swing doors. However, it is similarly possible that with two separate receiving spaces, for example a refrigerating space and a freezing space, each of these receiving spaces is closable by a separate door.

Preferably, the drink producing apparatus is accessible on the front side and exposed and not closed and covered by a door.

In an advantageous implementation, it is provided that the drink producing apparatus is arranged drawer-like in the receiving space and thus is retractable and extractable in depth direction of the household refrigeration apparatus. Thereby, the operability for dispensing mixed drinks can be simplified. An essential advantage of this configuration is to be regarded in that the accessibility to the housing of the mixed drink producing apparatus is simplified. In particular the accessibility to the containers and/or other further components in the housing is thereby allowed. It can then be provided that in the extracted state the interior of the housing of the drink producing apparatus can be accessed for example via openings in side walls closable by flaps.

The drink producing apparatus is also to be referred to as mixed drink producing apparatus if the drink to be dispensed has at least one liquid and an addition medium or at least two different liquids.

With indications of “top”, “bottom”, “front”, “rear”, “horizontal”, “vertical”, “depth direction”, “width direction”, “height direction” etc., the positions and orientations with intended use and intended arrangement of the apparatus and with an observer then standing in front of the apparatus and looking towards the apparatus are specified.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not have all of the features of an originally formulated independent claim. Moreover, implementations and feature combinations are to be considered as disclosed, in particular by the implementations set out above, which extend beyond or deviate from the feature combinations set out in the relations of the claims.

### BRIEF DESCRIPTION OF THE DRAWINGS

Below, embodiments of the invention are explained in more detail based on schematic drawings. There show:

FIG. 1 a perspective partial representation of an embodiment of a household refrigeration apparatus according to the invention;

FIG. 2 a schematic representation of partial components of an embodiment of a drink producing apparatus according to the invention as it can be installed in the household refrigeration apparatus according to FIG. 1;

FIG. 3 a schematic representation of partial components of an embodiment of a drink producing apparatus according to the invention, which are formed for position variation of partial components and setting a constant distance between a dispensing opening of a dispensing unit and a surface of a drink filled into a vessel;

FIG. 4 a schematic representation of partial components of a further embodiment of a drink producing apparatus according to the invention, which are formed for position variation of partial components and setting a constant distance between a dispensing opening of a dispensing unit and a surface of a drink filled into a vessel; and

FIG. 5 a schematic representation of partial components of a further embodiment of a drink producing apparatus according to the invention for position variation of partial components.

### PREFERRED EMBODIMENTS OF THE INVENTION

In the figures, identical or functionally identical elements are provided with the same reference characters.

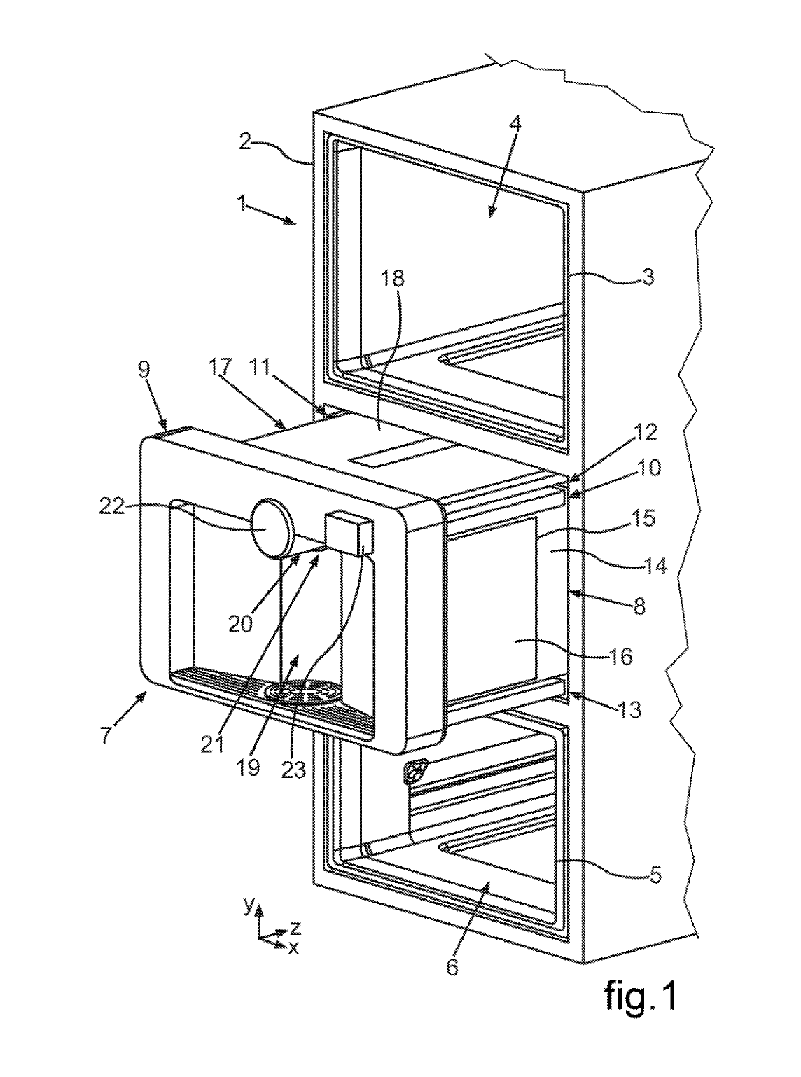

In FIG. 1, an embodiment of a household refrigeration apparatus 1 is illustrated in certain areas in a simplified perspective representation. Here, the household refrigeration apparatus 1 is for example a combined refrigerator-freezer, but can also be only a refrigerator or a freezer. The household refrigeration apparatus 1 is formed for storing and preserving food. It includes a housing 2, in which a first interior container 3 is disposed. Walls of the interior container 3 bound a first receiving space 4 for food, wherein this receiving space 4 is a refrigerating compartment.

Moreover, the household refrigeration apparatus 1 includes a further interior container 5, which bounds a second receiving space 6 with its walls, which is a freezing compartment. The two receiving spaces 4 and 6 are separated from each other. In the shown embodiment, the receiving spaces 4 and 6 are disposed one above the other in vertical direction and thus in height direction (y-direction). In the embodiment, they are preferably closable by non-shown, respectively separate doors, which are in particular pivotably fastened to the housing 2.

Moreover, the household refrigeration apparatus 1 includes a drink producing apparatus 7, which is a mixed drink producing apparatus in the embodiment.

However, the drink producing apparatus 7 can also be formed as a separate independent apparatus and thus be installed independently of a household refrigeration apparatus 1 and operable independently thereof.

The mixed drink producing apparatus 7 is disposed in a receiving area 8 of the housing 2. This receiving area 8 is separated from the receiving spaces 4 and 6. It can be provided that the receiving area 8 is bounded by walls of a separate interior container, which is also foamed in the housing 2. However, the receiving area 8 can also be formed integrated in the interior container 3 or the interior container 5.

In the embodiment, it is provided that the receiving area 8 is disposed between the receiving space 4 and the receiving space 6 in height direction.

The drink producing apparatus 7 is disposed accessible from the front side and thus from the front and the visible side. In particular, it is not closable and thus not coverable on the front side by a door.

The drink producing apparatus 7 has a housing 9.

In the embodiment, it is provided that the housing 9 and thus the entire mixed drink producing apparatus 7 can be extracted from and again retracted into the receiving area 8 in depth direction and thus in horizontal direction corresponding to the z-direction corresponding to a drawer. In FIG. 1, the completely extracted state is shown. However, the apparatus 7 can also be disposed fixedly installed.

Here, it is preferably provided that the horizontal displaceability is formed by a displacing device 10, which has multiple supporting positions. In the embodiment, it is provided that the displacing device 10 includes at least two, in particular four supporting positions. In the embodiment, they are formed as rails, which can also be extraction rails. In particular, here are disposed a first rail 11 in an upper left corner area, a second rail 12 in the upper right corner area, a third rail 13 in the lower right corner area and a further rail not recognizable in FIG. 1 in the lower left corner area. By this four-position support, a very secure and spread- and tilt-proof displacement, respectively, of the housing 9 is allowed.

Thus, the drink producing apparatus 7 is advantageously displaceably supported in the interior container 8. Advantageously, the displacing device 10 also has an extraction stop, by which the drink apparatus formed in particular as a drink producing apparatus 7 is secured in position in a completely extracted position shown in FIG. 1. Thus, over-extraction cannot be effected such that the drink producing apparatus 7 cannot fall out to the front and tilt downwards, respectively.

Advantageously, it is also provided that the displacing device 10 has a displacing protection, by which the drink producing apparatus 7 is disposed extraction-secured in the position completely retracted into the receiving area 8. Thereby too, undesired slipping out or protruding to the front then present is avoided. Undesired leakage or dripping of a liquid or hitting thereto is thereby prevented. This displacement protection can be a locking device. However, in addition or instead, a magnetic mount can for example also be provided.

Advantageously, an access 15 is formed at a vertical sidewall 14 of the housing 9, which is closed by a flap 16. After opening the flap 16, the interior of the housing 9 can be accessed such that the simple and unrestricted accessibility is allowed for purposes of exchange or filling. Additionally or instead, it can also be provided that a corresponding access is formed at an opposing further vertical sidewall 17 and/or at least one such access 15 is formed at a ceiling wall 18 of the housing 9.

Moreover, the drink producing apparatus 7 includes a recess or placing bay 19 on the front side, into which a drinking vessel can be placed, by which the mixed drink to be produced and dispensed by the drink producing apparatus 7 can then be collected. The drink producing apparatus 7 includes a dispensing unit 20 with in particular a single outlet or a dispensing opening 21. Preferably, it can be provided that an own outlet is respectively present for discharging each liquid from a container. Moreover, it can also be provided that an additive in powder form or gel form or further liquid form can additionally be admixed to this mixed drink to be produced, which can be produced and thus mixed from at least two different liquids. Thereto, it can in particular be provided that a capsule receptacle 22 is formed, into which a capsule having the mentioned additive or an addition medium can be inserted. Upon dispensing the mixed drink, this ingredient or additive is then removed from the capsule and added to the mixed drink in particular after dispensing into the drinking vessel effected via the dispensing opening 21.

Moreover, it can in particular be provided that the drink producing apparatus 7 has a capsule storage 23 or a capsule stock. A capsule or multiple capsules can be stored in this capsule storage 23 such that they are always present locally at the apparatus itself. In an advantageous implementation, it can be provided that this capsule storage 23 is cooled such that the capsules located therein can also be stored correspondingly cooled.

Preferably, it is provided that the capsule storage 23 can be opened by push-push mechanics and the capsules received therein are then freely accessible for example in the form of a displaceable storage in the form of a rail and for example can then be simply removed from above.

Moreover, it can also be provided that the drink producing apparatus 7 has a cartridge for admixing carbon dioxide into the mixed drink. Thereto, the accessibility for cartridge exchange is allowed via at least one present access 15. In an advantageous implementation, it is provided that the drink producing apparatus 7 is connected to a water connection external to household apparatus such that supply of water is for example allowed via a house water network. This has the additional advantage that a liquid to be added to the mixed drink as water does not have to be stored in a largely dimensioned container in the drink producing apparatus 7 but that this container can then be smaller dimensioned and can be refilled depending on demand and adapted to situation. It can then also be provided that such a water supply for producing the mixed drink is not supplied from the tank or the container provided for receiving this liquid in the drink producing apparatus 7, but additionally or instead can also be passed directly from this line to the dispensing unit 20 and thus also to the dispensing opening 21.

Thereby, in particular in production of hot drinks instead of a cold drink, the required energy for heating is reduced since the initial temperature of the water is higher. If carbonization of the mixed drink should then be desired, thus, this can be allowed via admixture of carbonized cold water, which is cooled in the drink producing apparatus 7, or by a carbonized second liquid, which is then present in the second container.

It is in particular provided that the drink producing apparatus 7 has a first container, in which a first liquid with a first freezing point, in particular water, is then provided or stored to then provide it for producing and dispensing a mixed drink depending on demand. Moreover, the drink producing apparatus 7 includes a second container separated therefrom, which is formed for receiving a second liquid different from the first liquid, which has a freezing point different form the first liquid. In particular, the first liquid is water and the second liquid is alcohol such that the mixed drink can also be an alcoholized mixed drink.

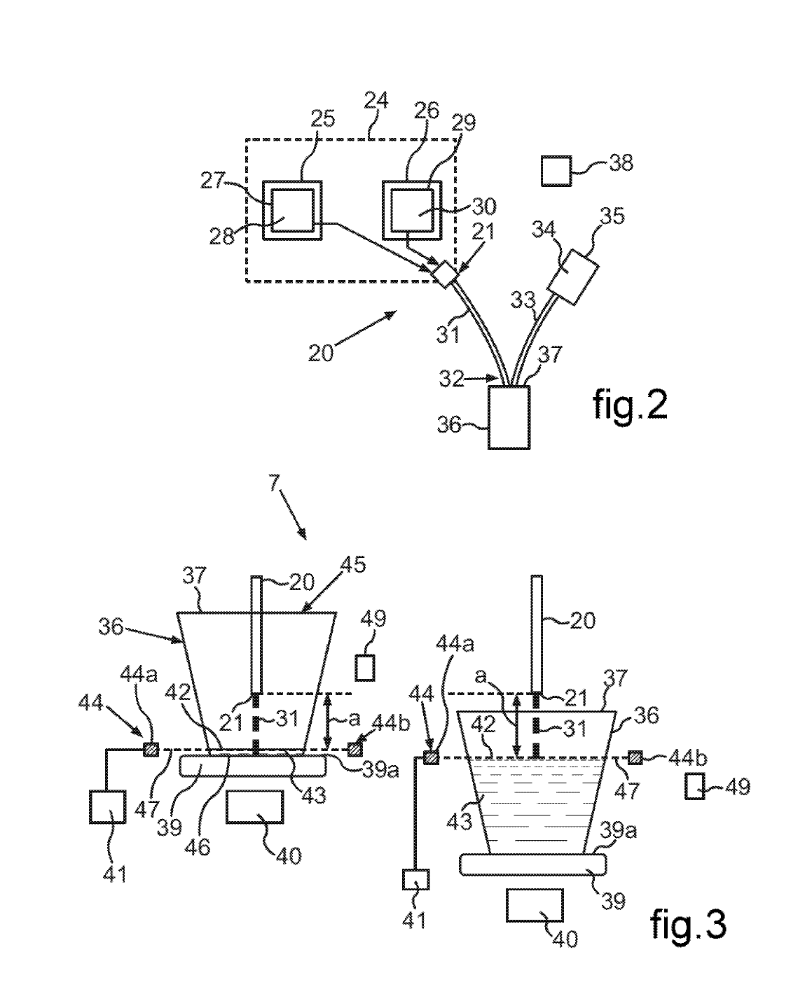

In FIG. 2, the household refrigeration apparatus 1 is shown with partial components of the drink producing apparatus 7 in a schematic representation. The household refrigeration apparatus 1 includes a refrigeration circuit 24, which is in particular a refrigeration circuit of the drink producing apparatus 7. In an advantageous implementation, this refrigeration circuit 24 includes a non-illustrated condenser, a compressor as well as a first evaporator 25 and a second evaporator 26 separate therefrom. The mixed drink producing apparatus 7 includes a first container or dispensing container 27, which is formed for receiving the first liquid 28 addable to the mixed drink, in the embodiment. The first dispensing container 27 is thermally coupled to the refrigeration circuit 24, in particular thermally coupled to the first evaporator 25. In an advantageous implementation, the first evaporator 25 surrounds the first dispensing container 27 on the outer side thereof at least in certain areas.

In the embodiment, it is provided that the drink producing apparatus 7 has a second container or dispensing container 29 separate from the first dispensing container 27, which is formed for receiving a second liquid 30 different from the first liquid, which can also be added to the mixed drink. Here too, it is preferably provided that the second evaporator 26 is thermally coupled to the second dispensing container 29, in particular surrounds it on the outer side thereof at least in certain areas.

In particular, it is provided that the first liquid 28 is or has water and the second liquid 30 is or contains alcohol.

In FIG. 2, dispensing of the two liquids 28 and 30 from the dispensing containers 27 and 29 is then illustrated by arrows in sketchy manner in the schematic representation, and the two liquids 28 and 30 are mixed to a common liquid jet 31 in an advantageous implementation. However, dispensing of a jet of only one of the two liquids 28 and 30 can also be provided.

In particular, it is provided that the jet 31 is formed after exit from the dispensing opening 21 at a place of meeting 32 with a jet 33 of an additive or addition medium 34, which is contained in a capsule 35 disposed in the mixed drink producing apparatus 7, after the dispensing opening 21, but before entry into a receiving vessel 36 with regard to the height position viewed in vertical direction. In particular, this place of meeting 32 is above a border 37 of the receiving vessel 36 in vertical direction. Mixing between the jet 31 and the jet 33 then desirably improved already before entry into the receiving vessel 36 is thereby achieved.

Therein, the receiving vessel 38 is placed in the placing bay 19 (FIG. 1).

The drink producing apparatus 7 also includes a control unit 38 for controlling the dispensing of the mixed drink.

In FIG. 3, the drink producing apparatus 7 is shown in partial components in a schematic representation. Here, a receiving device 39 is exemplarily illustrated, which is formed for receiving the vessel 36. As is apparent in FIG. 3, the receiving device 39 is exemplarily formed as a plate, on which the vessel 36 is placed. A surface 39a can be flatly formed. However, this surface 39a can also have a well, into which the vessel 36 is placed. Thereby, secure stand of the vessel 36 is achieved. The drink producing apparatus 7 moreover has a position variation device 40, by which a position between the dispensing opening 21 and the receiving device 39 is variable. In particular, a vertical position variation can here be effected. The position variation device 40 can be purely mechanically, hydraulically, pneumatically, electromechanically or the like formed. Here, a corresponding servo-motor can be provided, which allows this vertical position variation. Similarly, a lifting cylinder can for example be provided. This vertical position variation can be continuously effected by the position variation device 40.

Moreover, the drink producing apparatus 7 includes a distance setting device 41, by which a vertical distance a between the dispensing opening 21 and a reference location in the vessel 36, for example a surface 42 of the carbonized liquid 43 filled into the vessel 36, is kept constant during the dispensing process of the carbonized liquid. The distance setting device 41 can be coupled to the control unit 38 and be formed for communication with it. However, the distance setting device 41 can also be constituted by the control unit 38.

It can be provided that the receiving device 39 is variable in this vertical position by the position variation device 40. In addition or instead, it can be provided that the dispensing unit 20 is variable in its vertical position by the position variation device 40. It can also be provided that the distance setting device 41 and the position variation device 40 are two separate units, which are formed for communication with each other. It can also be provided that the distance setting device 41 and the position variation device 40 constitute a common unit.

The distance setting device 40 includes at least one detector unit 44, by which the surface 42 of the liquid 43 in the vessel 36 or a vessel bottom 46 is detectable in non-contacting manner with the liquid 43. The detector unit 44 can be an optical detector unit and for example be an infrared detector unit. However, the detector unit 44 can for example also be at least one ultrasonic sensor.

In the embodiment in FIG. 3, it is apparent that the vertical distance a is set small and is less than 5 cm in this context.

For producing and dispensing the drink, it is provided that the vessel 36 is first placed on the receiving device 39. In this situation, the receiving device 39 is then in a receiving position, in which the vessel 36 can be placed thereon. In this placing position, the dispensing unit 20 and the receiving device 39 are far apart from each other such that the vessel 36 can be placed onto the receiving device 39 in particular with a purely horizontal movement and the dispensing unit 20 is not in the way thereto. When this placing position of the vessel 36 on the receiving device 39 is then reached, dispensing of a drink can then be performed, wherein a user for example actuates an operating element thereto. Before starting the dispensing process and thus before dispensing the liquid 28 and/or 30 from the dispensing opening 21, a basic position between the dispensing opening 21 and the receiving device 39 is then set such that a then given and defined basic position between the vessel 36 and the dispensing opening 21 is set here too. The basic position is reached starting from this placing position in that the receiving device 39 and the dispensing opening 21 are moved towards each other viewed in vertical direction.

In the embodiment in FIG. 3, it is provided thereto that the dispensing unit 20 remains in its local position and only the receiving device 39 is lifted starting from this placing position and is moved towards the dispensing unit 20. When the basic position is then reached, thus, the dispensing unit 20 preferably immerses into the vessel 36 from above via a filling opening 45 of the vessel 36 as it is schematically shown in FIG. 3 until the basic position shown in FIG. 3 is then reached, as it is illustrated in the left image in FIG. 3. In the basic position, this vertical distance a is then preferably already set, which is then kept constant in the following dispensing process. In this left image in FIG. 3, the distance a between the dispensing opening 21 and a vessel bottom 46 of the vessel 36 is then determined before dispensing this jet 31 since a surface 42 is not yet present. In particular, this can be effected by means of the distance setting device 41 and in particular the detector unit 44. In a configuration as an optical detector unit 44, for example by reflection and/or scattering of light beams between an emitter 44a and a receiver 44b of the detector unit 44, it can be concluded therefrom where this vessel bottom 46 is anyway. A corresponding light beam or a corresponding optical signal 47, which is emitted in horizontal direction and can be received by the receiver 44b, then is indicative of the respective situations. A vertical distance between the detector unit 44 and the dispensing opening 21 can be kept constant during the dispensing process.

In FIG. 3, a situation is shown in the left image, in which the dispensing process of the jet 31 is then already started and a certain amount of this carbonized liquid 43 has already flown into the vessel 36 in this context. Thereby, with respect to that situation, as it was just explained and represents the basic position, certain filling of the vessel 36 has arisen and the vertical distance a is then still kept constant here too. This is effected to the effect that the already present filling level 24 is then captured by means of the detector unit 44 and the receiving device 39 is then also adjusted by the position variation device 40 depending thereon, namely is again moved downwards. By the dynamic filling of the vessel 36, thus, the receiving device 39 is again moved downwards away from the dispensing unit 20 here stationarily arranged and thus also the dispensing opening 21 during the receiving process. This is effected such that the vertical distance a is always kept constant.

In this context, the vertical distance between the detector unit 44 and the dispensing opening 21 is also constant.

In the right image in FIG. 3, a state is then shown, in which considerably more liquid 43 has already flown into the vessel 36 and the vertical distance a between dispensing opening 21 and surface 42 is here set and thus corresponds to that as it was at the beginning of the dispensing process and is set in the left image in FIG. 3, respectively.

The possibility explained to FIG. 2 of also adding an addition medium 34 by means of the jet 33 can also be provided in the implementation in FIG. 3. In particular, it is then also provided that the addition of the jet 33 is advantageously still effected in the dispensing unit 20 or the capsule 34 is then also arranged in the basic position immersing into the vessel 36 according to the representation in the left image in FIG. 3.

In the right image in FIG. 3, a state is then in particular reached, in which a sufficient amount of the desired drink is filled into the vessel 36 such that the dispensing process can then be terminated.

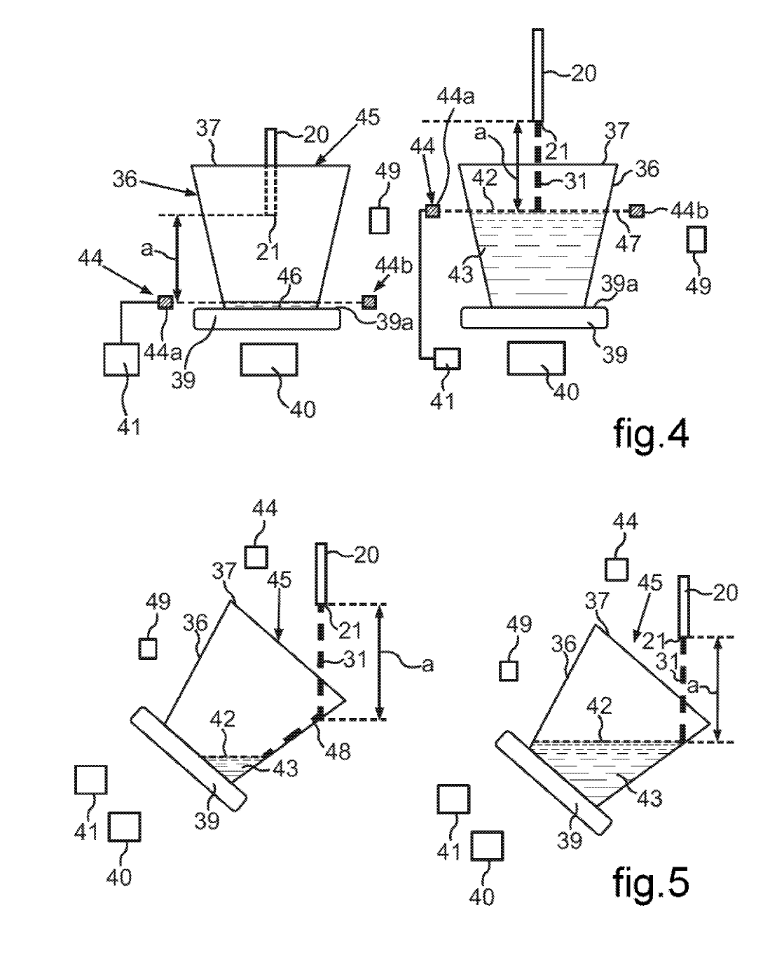

In FIG. 4, a further embodiment is shown, in which the dispensing unit 20 is variable in its position at least in vertical direction in contrast to FIG. 3. In the left image in FIG. 4, the state is again shown as it was already explained in detail in the left image in FIG. 3. When the dispensing process of at least one carbonized liquid 28 and/or 30 as the drink to be dispensed is then started, the dispensing unit 20 is then successively moved upwards and thus moved away from the vessel 36. Here too, this is again effected such that the distance a is continuously kept constant in filling into the vessel 36. In the right image in FIG. 4, the state is then again shown, in which the dispensing process has proceeded and corresponding liquid 43 is contained in the vessel 36.

It is also to be mentioned to the embodiments explained in FIG. 3 and FIG. 4 that the first liquid 28 or the second liquid 30 or a mixture of the first liquid 28 and the second liquid 39 is to be understood by the liquid 43. Therefore, the liquid 43 also represents the drink to be formed, which is in the vessel 36.

In the previous embodiments, the position variation of the mentioned components was only explained in vertical direction. In addition or instead, tilting can also be provided, as it is indicated in FIG. 5. In this implementation, it can be provided that the detector unit 44 is at least one ultrasonic sensor, which captures the filling level and thus the surface 42 via the filling opening 45 of the vessel 36. In the representation in FIG. 5, in the left image there, a state is again shown, in which the dispensing process is already started, but relatively little liquid 43 is still contained in the vessel 36. Here, it is provided that before the start of the dispensing process, starting from the placing position already explained to FIG. 3 and FIG. 4, in which the receiving device 39 is still horizontally oriented, the receiving device 39 is tilted by a corresponding angle around this horizontal and the tilted basic position reached in the left image in FIG. 5 is then set. In this configuration, it is then provided that the vertical distance a is also kept constant during the dispensing process. By means of the position variation device 40 and the distance setting device 41, a tilting operating of the receiving device 39 and/or vertical displacement of the receiving device 39 is then performed such that this vertical distance a is kept constant.

It can be provided that the detector unit 44 is movable itself and thus is variable in the position also in the implementation in FIG. 5. Depending on the movements of the vessel 36, the surface 42 can then always be securely and accurately detected here too and thereby the movement of the vessel 36 can also be determined.

In the implementation according to FIG. 5, it can additionally or instead also be provided that the distance a between the dispensing opening 21 and a specific defined place of impingement 48 in the interior of the vessel 36 is determined such that the vertical distance a has a magnitude here too, which avoids undesired severe impact of the jet 31 and severe splash resulting therefrom such that undesired loss of carbonic acid from the jet 31 then does not occur here too.

Generally speaking, the distance a is preferably defined and determined such that upon impingement of the jet 31 the splash measure is less than a threshold value such that the exit of carbonic acid from the jet 31 does not exceed an also presettable threshold value derived therefrom. Such threshold values can be determined by prior trials and experiments for individual compositions of the jet 31 with regard to the types of the liquid mediums contained therein and/or with regard to the degree of carbonization. Therefore, it is also possible that the distance a can be set depending on the type of the liquid and/or depending on the degree of the carbonization of the jet 31. Thereto, a corresponding table can in particular be recorded in the control unit 38. It can be provided that the drink producing apparatus 7 has individual capturing units such as for example sensors, by which the degree of the carbonization can be determined and/or a table is recorded based on the information of the liquids, which are to be added to the drink, in which the associated distance a can then be input depending thereon. Thus, if an individual degree of carbonization and/or an individual composition of the drink with liquids are provided in this respect and this is correspondingly selected or preset by a user via an input unit of the drink producing apparatus 7, the correct and preferred vertical distance a can then also individually be automatically set in user-individual manner. Thereby, by different vertical distances a, with drinks differently to be produced and to be dispensed, the preferred taste can then always be maintained and thus a high level of quality of the drinks to be produced can also be satisfied. The sensors mentioned in this respect, can for example be disposed in the dispensing unit 20 and/or in the housing of the drink producing apparatus 7, for example also in a dispensing container.

As is also symbolically shown in the explained embodiments, the drink producing apparatus 7 also includes a capturing device 49, wherein the capturing device 49 is formed for capturing at least one geometric quantity of a vessel 36, into which the liquid 28, 30 to be dispensed is to be filled. This capturing device 49 is in particular formed for capturing at least one geometric quantity if the vessel 36 is arranged on the receiving device 39. For example, the height or the width or the depth or the shape of the vessel 36 is to be mentioned as the geometric quantity.

The distance setting device 41 mentioned in the embodiments is in particular formed for non-contact detection. A vertical distance a between the dispensing opening 21 and a local reference location of the vessel 36 is formed by the vessel bottom 46 or the surface 42 of the liquid 43 already filled into the vessel 36 or by the place of impingement 48 on an inner side of the sidewall of the vessel 36 in the embodiments.

In particular, it is provided that the distance setting device 41 is formed for communication with the position variation device 40 and an orientation of the vessel 36 in space and/or a height position of the vessel 36 and/or a speed of a position variation of the vessel 36 are variable in a dispensing process of the liquid 28 and/or 30 depending on the captured surface 42 of the liquid 43 filled into the vessel 36 or the vessel bottom 46 or the place of impingement 48 of the vessel 36. Thereby, the vertical distance a between the dispensing opening 21 and the surface 42 or the vessel bottom 46 or the place 48 is then kept constant. Similarly, the same can be provided if the vertical distance a between the dispensing opening 21 and the surface 42 of the liquid 43 or the vessel bottom 46 or the place 48 is to be kept constant if the dispensing opening 21 is adjustable in height. Here too, a communication of the distance setting device 41 with the position variation device 40 can then be provided and an orientation of the dispensing opening 21 in space and/or in height position of the dispensing opening 21 and/or a speed of a position variation of the dispensing opening 21 can be variable in a dispensing process of the liquid 28 and/or 30 depending on the captured surface 32 of the liquid 43 filled into the vessel 36 and/or above the vessel bottom 46. In particular, it can also be provided that the vertical distance a between the dispensing opening 21 and the surface 42 of the liquid 43 or between the dispensing opening 21 and the vessel bottom 46 is kept constant depending on the geometric parameter of the vessel 36. It can also be provided that the vertical distance a between the dispensing opening 21 and the surface 42 of the liquid already filled into the vessel 36 is kept constant depending on the type of the liquid 28 and/or 30, which is dispensed into the vessel 36 for producing the drink.

At the beginning of the dispensing process, the vertical distance a is measured between the dispensing opening 21 and the vessel bottom 36 when liquid 43 is not yet contained in the vessel 26. With the beginning of filling the liquid 28 and/or 30 into the vessel 36 such that liquid 43 is then contained in the vessel 36, this consistent distance a between the dispensing opening 21 and the surface 42 is then measured and kept constant. This is effected by a dynamic relative movement process between the dispensing opening 21 and the vessel 36.

### LIST OF REFERENCE CHARACTERS

1 Household refrigeration apparatus

2 housing

3 interior container

4 first receiving space

5 interior container

6 second receiving space

7 mixed drink producing apparatus

8 receiving area

9 housing

10 displacing device

11 rail

12 rail

13 rail

14 sidewall

15 access

16 flap

17 sidewall

18 ceiling wall

19 placing bay

20 dispensing unit

21 outlet

22 capsule receptacle

23 capsule storage

24 refrigeration circuit

25 first evaporator

26 second evaporator

27 first dispensing container

28 first liquid

29 second dispensing container

30 second liquid

31 jet

32 place of meeting

33 jet

34 addition medium

35 capsule

36 vessel

37 border

38 control unit

39 receiving device

39a surface

40 position variation device

41 distance setting device

42 surface

43 carbonized liquid

44 detector unit

44a emitter

44b receiver

45 filling opening

46 bottom

47 signal

48 place of impingement

49 capturing device

a vertical distance

1. Drink producing apparatus comprising:
a dispensing unit for dispensing carbonized liquid from the drink producing apparatus,
a dispensing container, which is formed for receiving a carbonized liquid addable to a drink by the drink producing apparatus, wherein
the dispensing container is connected to the dispensing unit of the drink producing apparatus for leading the carbonized liquid from the dispensing container to the dispensing unit,
the dispensing unit comprises a dispensing opening, from which the carbonized liquid can be dispensed,
a receiving device for receiving a vessel, wherein the carbonized liquid to be dispensed from the dispensing opening can be filled into the vessel,
a position variation device, by which a position between the dispensing opening and the receiving device is variable, and
a distance setting device, by which a vertical distance between the dispensing opening and a local reference location at or in the vessel is kept constant during the dispensing process of the carbonized liquid.

2. Drink producing apparatus according to claim 1, wherein the reference location is a surface of the liquid already filled into the vessel or a vessel bottom of the vessel, and the distance setting device comprises at least one detector unit, by which there is detectable the surface of the filled liquid in the vessel in non-contacting manner with the filled liquid or the vessel bottom in non-contacting manner.

3. Drink producing apparatus according to claim 2, wherein the detector unit is an optical detector unit.

4. Drink producing apparatus according to claim 3, wherein the optical detector unit is an infrared detector unit.

5. Drink producing apparatus according to claim 3, wherein the optical detector unit is arranged such that in the state, in which the vessel is disposed on the receiving device, a light beam of the optical detector unit captures the surface of the filled liquid or the vessel bottom laterally through the vessel.

6. Drink producing apparatus according to claim 2, wherein the detector unit comprises at least one ultrasonic sensor.

7. Drink producing apparatus according to claim 6, wherein the ultrasonic sensor is arranged such that in the state, in which the vessel is arranged on the receiving device, an ultrasonic signal of the ultrasonic sensor captures the surface of the filled liquid or the vessel bottom from above through a filling opening of the vessel.

8. Drink producing apparatus according to claim 2, wherein the detector unit is arranged in a vertical distance to the dispensing opening and this vertical distance is constant during a dispensing process of the liquid and corresponds to the vertical distance between the dispensing opening and the surface of the filled liquid or the vessel bottom.

9. Drink producing apparatus according to claim 1, wherein the position variation device is formed for height adjustment and/or for tilting the receiving device.

10. Drink producing apparatus according to claim 1, wherein the position variation device is formed for height adjustment and/or for tilting the dispensing opening.

11. Drink producing apparatus according to claim 1, wherein the mixed drink producing apparatus comprises a capturing device, wherein the capturing device is formed for capturing at least one geometric quantity of a vessel, into which the liquid to be dispensed is to be filled when the vessel is arranged on the receiving device.

12. Drink producing apparatus according to claim 11, wherein the geometric quantity is a height or a width or a depth of the vessel.

13. Drink producing apparatus according to claim 1, wherein the distance setting device is formed for communication with the position variation device, and an orientation of the vessel in space and/or a height position of the vessel and/or a speed of a position variation of the vessel are variable in a dispensing process of the liquid depending on the captured surface of the liquid filled into the vessel or the vessel bottom, and thereby the vertical distance between the dispensing opening and the surface of the liquid in the vessel or the vessel bottom is kept constant.

14. Drink producing apparatus according to claim 1, wherein the distance setting device is formed for communication with the position variation device, and an orientation of the dispensing opening in space and/or a height position of the dispensing opening and/or a speed of a position variation of the dispensing opening are variable in a dispensing process of the liquid depending on the captured surface of the liquid filled into the vessel or the vessel bottom, and thereby the vertical distance between the dispensing opening and the surface of the liquid or the vessel bottom is kept constant.

15. Household refrigeration apparatus comprising a housing, in which a receiving space for food is formed, and a drink producing apparatus comprising:
a dispensing unit for dispensing carbonized liquid from the drink producing apparatus,
a dispensing unit for dispensing carbonized liquid from the drink producing apparatus,
a dispensing container, which is formed for receiving a carbonized liquid addable to a drink by the drink producing apparatus, wherein
the dispensing container is connected to the dispensing unit of the drink producing apparatus for leading the carbonized liquid from the dispensing container to the dispensing unit,
the dispensing unit comprises a dispensing opening, from which the carbonized liquid can be dispensed,
a receiving device for receiving a vessel, wherein the carbonized liquid to be dispensed from the dispensing opening can be filled into the vessel,
a position variation device, by which a position between the dispensing opening and the receiving device is variable, and
a distance setting device, by which a vertical distance between the dispensing opening and a local reference location at or in the vessel is kept constant during the dispensing process of the carbonized liquid.

16. Method for producing and dispensing a drink with a drink producing apparatus comprising the following steps of:
providing a dispensing container, which is formed for receiving a carbonized liquid addable to a drink by the drink producing apparatus,
providing a dispensing unit of the drink producing apparatus,
connecting the dispensing container to a dispensing unit for leading the carbonized liquid from the dispensing container to the dispensing unit,
placing a vessel on a receiving device of the drink producing apparatus,
dispensing a jet of the at least one carbonized liquid from a dispensing opening of the dispensing unit into the vessel,
capturing a reference location at or in the vessel during the dispensing process,
varying a position between the dispensing opening and the receiving device during the dispensing process of the carbonized liquid,
keeping a vertical distance between the dispensing opening and the reference location constant during the dispensing process of the carbonized liquid into the vessel.

17. Method according to claim 16, wherein before dispensing the liquid from the dispensing opening, a basic position between the dispensing opening and the vessel is set and during the dispensing process the vessel and the dispensing opening are moved away from each other in their position to each other such that the vertical distance between the dispensing opening and the surface of the liquid already filled into the vessel is kept constant.

18. Method according to claim 17, wherein the receiving device is moved relatively to the dispensing opening for the variation of the position between the dispensing opening and the vessel.

19. Method according to claim 17, wherein the dispensing opening is moved relatively to the receiving device for the variation of the position between the dispensing opening and the vessel.

20. Method according to claim 16, wherein at least one geometric parameter characterizing the vessel is determined and the vertical distance between the dispensing opening and the surface of the liquid in the vessel is kept constant during the dispensing process depending on this geometric parameter.

21. Method according to claim 16, wherein the vertical distance between the dispensing opening and the surface of the liquid in the vessel is kept constant during the dispensing process depending on the type of the liquid which is dispensed into the vessel.
